(19) United States
(12) Patent Application Publication
(10) Pub. No.: US 2014/0132977 A1
(43) Pub. Date: May 15, 2014

(54) IMAGE FORMING APPARATUS

(71) Applicant: Konica Minolta, Inc., Tokyo (JP)

(72) Inventors: Michio TAKAHASHI, Kozakai-Chou (JP); Junichi Arai, Chiryuu-shi (JP); Hiroshi Eguchi, Okazaki-shi (JP)

(73) Assignee: Konica Minolta, Inc., Tokyo (JP)

(21) Appl. No.: 14/045,827

(22) Filed: Oct. 4, 2013

(30) Foreign Application Priority Data
Nov. 13, 2012 (JP) 2012-249240

(51) Int. Cl. H04N 1/00

(52) U.S. Cl. CPC H04N 1/00891
USPC 358/1.14

(57) ABSTRACT

An image forming apparatus includes control units that are booted up in parallel after reset, and further includes: a display unit displaying, in multiple stages, overall boot-up progress that is boot-up progress of the entire apparatus; a display control unit controlling the display unit to display the overall boot-up progress, wherein the display control unit includes: an estimation subunit making estimation of the overall boot-up progress based on period counted after the reset; and a reception subunit receiving boot-up progress of each control unit, and until receiving the boot-up progress of each control unit or the boot-up progress of the latest control unit in terms of boot-up completion, the display control unit performs control based on the estimation, and after receiving the boot-up progress of each control unit or the boot-up progress of the latest control unit, the display control unit performs control based on the received boot-up progress.

### CROSS-REFERENCE TO RELATED APPLICATIONS

This application is based on application No. 2012-249240 filed in Japan, the contents of which are hereby incorporated by reference.

### BACKGROUND OF THE INVENTION

(1) Field of the Invention

The present invention relates to an image foaming apparatus, and particularly to an art of displaying a boot-up progress of the image forming apparatus with a high precision.

(2) Related Art

Conventionally, there has been widely known an art of notifying a user of a boot-up progress of an image forming apparatus by displaying animation or the like on an operation panel after power-on. However, the boot-up progress cannot be displayed on the operation panel until the controller unit has completely booted up because the operation panel is under control by a so-called controller unit.

In response to this problem, Japanese Patent Application Publication No. 2009-066886 for example proposes an art of providing a sub display controller which operates independently from a main CPU (Central Processing Unit) included in the controller unit so as to display a message indicating “Please wait for a minute” or the like until the main CPU has completely booted up after power-on. With this structure, it is possible to provide a certain display with the user of the image forming apparatus even before the controller unit has not yet completely booted up.

According to the image forming apparatus relating to the above conventional art, however, a fixed message is only displayed. This causes a problem that the user of the image forming apparatus cannot know a boot-up progress which indicates a progress degree of boot-up of the image forming apparatus. This might make the user to feel anxious because of not knowing whether boot-up is in normal progress or stagnant.

Compared with this, there has been considered a method of incorporating progress display processing into boot-up processing of the controller unit to perform display progress even before the controller unit has completely booted up. However, enlargement of the boot-up processing causes delay in boot-up completion, and furthermore delay in warming-up completion. For this reason, it is desirable to display the boot-up progress without delaying warming-up completion.

In addition, boot-up completion of the entire image forming apparatus has been conventionally synonymous with warming-up completion of a fixing device for fixing toner images onto recording sheets. However, while a warming-up period of the fixing device is becoming shorter, a pre-processing device is becoming complicated for performing bookbinding processing and the like on recording sheets onto which toner images have been fixed and a boot-up period of the pre-processing device is becoming longer. For this reason, it is becoming difficult to know the boot-up progress of the image forming apparatus with a high precision, only by focusing on the warming-up period of the fixing device.

### SUMMARY OF THE INVENTION

The present invention was made in view of the above problem, and aims to provide an image forming apparatus capable of displaying a boot-up progress with a higher precision both before and after boot-up completion of the controller unit without delaying warming-up completion of the image forming apparatus.

In order to achieve the above aim, the image forming apparatus relating to the present invention includes a plurality of control units that are booted up in parallel after reset of the image forming apparatus, the image forming apparatus comprising: a display unit that displays, in multiple stages, an overall boot-up progress that is a boot-up progress of the entire image forming apparatus; a display control unit that controls the display unit to display the overall boot-up progress, wherein the display control unit includes: an estimation subunit that makes an estimation of the overall boot-up progress based on a period counted after the reset; and a reception subunit that receives a boot-up progress of each of the control units, and until receiving the boot-up progress of each of all of the control units, or until receiving the boot-up progress of a latest one of the control units in terms of completion of boot-up, the display control unit controls the display unit to display the overall boot-up progress based on the estimation, and after receiving the boot-up progress of each of all of the control units, or after receiving the boot-up progress of the latest control unit, the display control unit controls the display unit to display the overall boot-up progress based on the received boot-up progress.

### BRIEF DESCRIPTION OF THE DRAWINGS

These and other objects, advantages and features of the invention will become apparent from the following description thereof taken in conjunction with the accompanying drawings those illustrate a specific embodiments of the invention.

In the drawings:

FIG. 1 shows the main configuration of an image forming apparatus relating to an embodiment of the present invention;

FIG. 2 shows the main configuration of an illumination control unit 101;

FIG. 3 is an outer appearance perspective view of the main configuration of an illumination display subunit 203;

FIG. 4 is a time chart exemplifying a boot-up of each of the illumination control unit 101, a controller unit 102, and an engine unit 103;

FIG. 5 is a flow chart of a main routine executed by an illumination display control subunit 202;

FIG. 6 is a flow chart of estimation display processing performed by the illumination display control subunit 202;

FIG. 7 is a flow chart of estimation display processing performed by the illumination display control subunit 202;

FIG. 8 exemplifies progress display performed by the illumination display subunit 203;

FIG. 9 shows the configuration of an image forming apparatus relating to a modification example of the present invention;

FIG. 10 shows the configuration of an image forming apparatus relating to a modification example of the present invention;

FIG. 11 shows the configuration of an image forming apparatus relating to a modification example of the present invention;

FIG. 12 exemplifies progress display performed by the illumination display subunit 203;

### DESCRIPTION OF PREFERRED EMBODIMENTS

The following describes an embodiment of an image forming apparatus relating to the present invention, with reference to the drawings.

### [1] CONFIGURATION OF IMAGE FORMING APPARATUS

Firstly, description is given on the configuration of the image forming apparatus relating to the present embodiment.

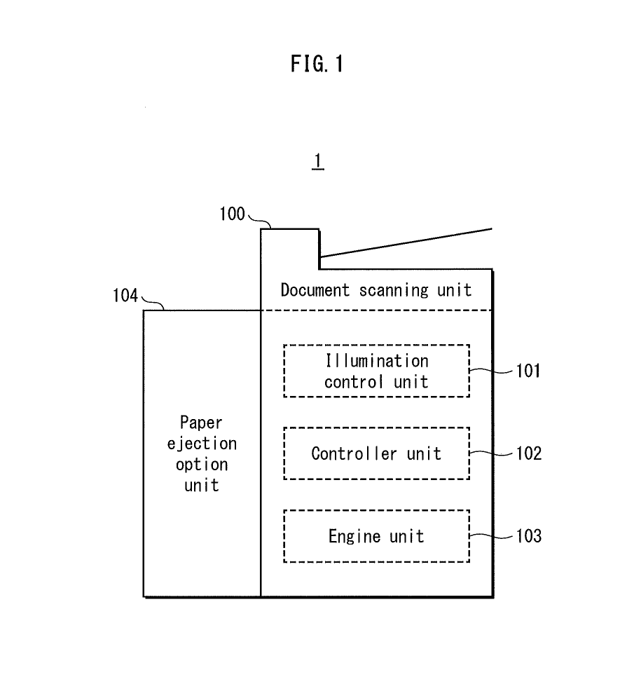

As shown in FIG. 1, an image forming apparatus 1 includes a document scanning unit 100, an illumination control unit 101, a controller unit 102, an engine unit 103, and a paper ejection option unit 104.

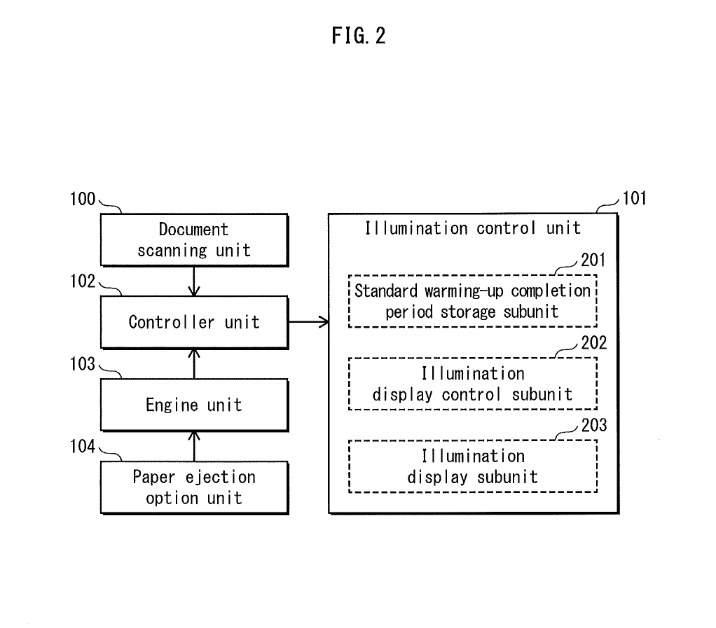

The illumination control unit 101 is a unit for displaying a boot-up progress (hereinafter, also referred to as performing progress display) of the image forming apparatus 1. As shown in FIG. 2, the illumination control unit 101 includes a standard warming-up completion period storage subunit 201, an illumination display control subunit 202, and an illumination display subunit 203. The standard warming-up completion period storage subunit 201 stores therein a standard warming-up completion period after which the entire image forming apparatus 1 becomes able to perform printing, such as a period of 20 sec to 180 sec.

The illumination display control subunit 202 receives, from the controller unit 102, a progress notification indicating a boot-up progress of each of a plurality of control units, namely, the document scanning unit 100, the controller unit 102, the engine unit 103, and the paper ejection option unit 104. Then, the illumination display control subunit 202 controls the illumination display subunit 203 to perform illumination display of the boot-up progress of the image forming apparatus 1. The controller unit 102 notifies the illumination display subunit 203 of a period remaining till warming-up completion (boot-up completion) (hereinafter, referred to as a remaining period) in units of milliseconds as the progress notification.

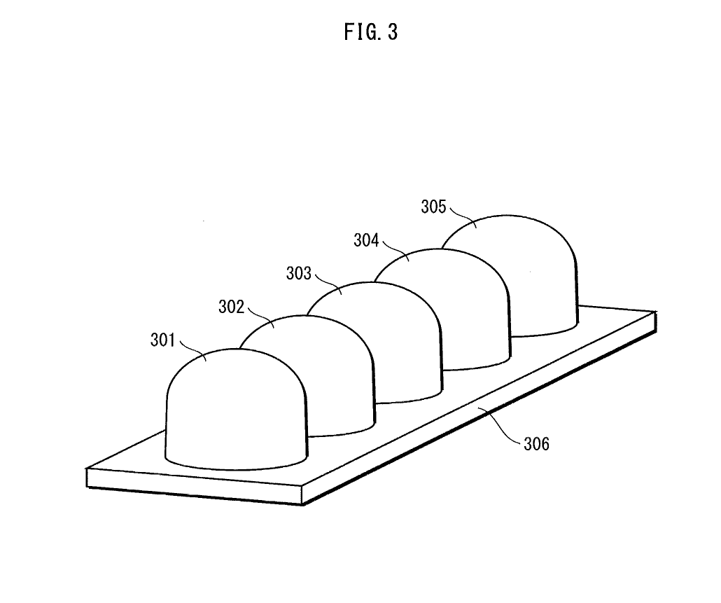

The illumination display subunit 203 includes a plurality of LEDs (Light Emitting Diodes) which are individually turned on and turned off, and performs illumination display of the boot-up progress under control by the illumination display control subunit 202. In the present embodiment, five LEDs, namely, LEDs 301 to 305 are arranged in a row on a substrate 306 as shown in FIG. 3. The illumination display subunit 203 displays the boot-up progress in six stages from 0% to 100% with 20% increments in between, in accordance with the number of LEDs which are turned on from zero to five.

The document scanning unit 100 scans an image of a document to generate digital image data of the document. Also, upon start of boot-up of the image forming apparatus 1, while cleaning a scanning subunit thereof, performing shading correction, and so on, the document scanning unit 100 transmits a progress notification thereof to the controller unit 102.

The controller unit 102 integrally controls the document scanning unit 100, the engine unit 103, and an operation panel which is not illustrated. Upon start of boot-up of the image forming apparatus 1, while performing boot-up processing, processing of activating an application program, and so on, the controller unit 102 transmits, to the illumination control unit 101, a progress notification thereof and progresses notifications received from the document scanning unit 100 and the engine unit 103.

The engine unit 103 performs image forming processing. Upon start of boot-up of the image forming apparatus 1, while performing image stabilization processing and so on, the engine unit 103 transmits, to the controller unit 102, a progress notification thereof and a progress notification received from the paper ejection option unit 104.

The paper ejection option unit 104 performs post-processing on print pieces created by the engine unit 103. The post-processing is, for example, staple processing and gluing bookbinding processing. Upon start of boot-up of the image forming apparatus 1, while performing processing of melting glue to be used for the gluing bookbinding processing and so on, the paper ejection option unit 104 transmits a progress notification thereof to the engine unit 103.

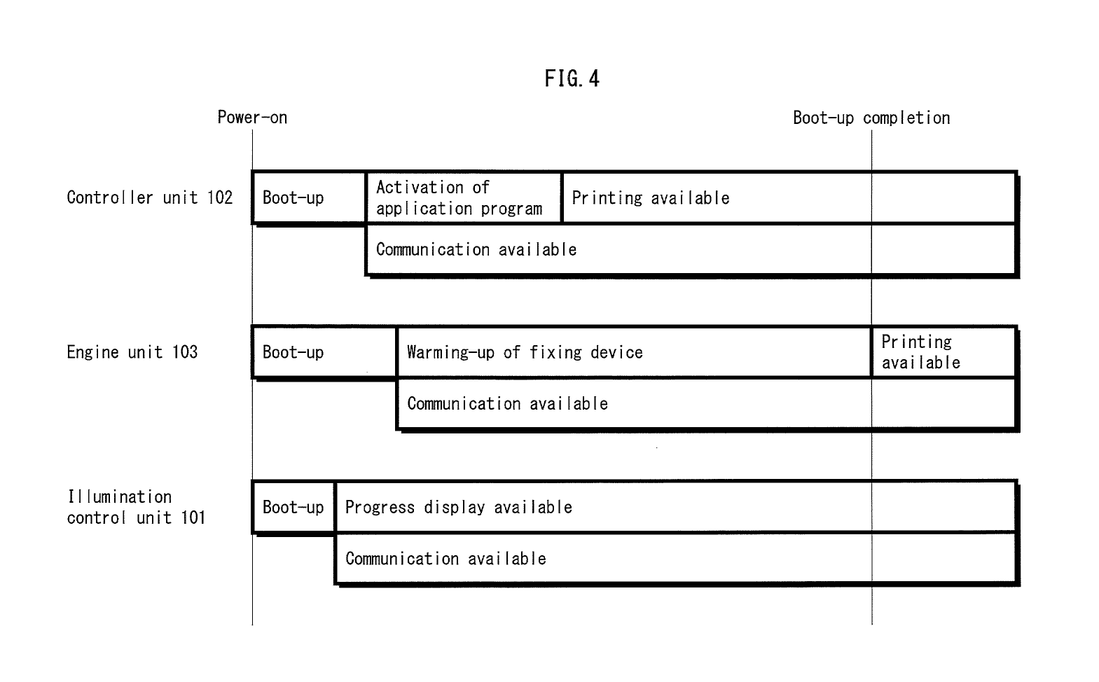

Upon start of boot-up of the image forming apparatus 1, the illumination control unit 101 performs boot-up processing. This boot-up processing performed by the illumination control unit 101 completes faster than those performed by the controller unit 102, the engine unit 103, and so on as shown in FIG. 4. Upon power-on, the illumination control unit 101 starts boot-up processing. After completing the boot-up processing, the illumination control unit 101 becomes able to communicate with the controller unit 102 and so on, and also becomes able to perform progress display.

On the other hand, after completing boot-up processing, the controller unit 102 becomes able to communicate with the document scanning unit 100, the illumination control unit 101, and so on, and also starts activating an application program. After completing the activation of the application program, the controller unit 102 becomes able to perform printing.

In the present embodiment, the engine unit 103 takes longer time to complete boot-up processing than the controller unit 102. After completing the boot-up processing, the engine unit 103 becomes able to communicate with the controller unit 102, the paper ejection option unit 104, and so on, and also starts warming-up of the fixing device. The warming-up of the fixing device is processing of increasing a temperature of a fixing member, which is to be used for heating and inciting toners carried on recording sheets, to a predetermined temperature. After completing the warming-up of the fixing device, the engine unit 103 becomes able to perform printing.

In the example shown in FIG. 4, a boot-up completion time of the entire image forming apparatus 1 coincides with a boot-up completion time of a configuration part, which is managed by a control unit (the engine unit 103) whose boot-up progress is the latest among the plurality of control units (the engine unit 103 and the controller unit 102) other than illumination control unit 101, becomes able to perform printing. In other words, the boot-up completion time of the entire image forming apparatus 1 coincides with a time when all of the control units each have output a signal indicating boot-up completion thereof. This time corresponds to a time indicated by a vertical line “boot-up completion” in FIG. 4.

Note that FIG. 4 omits a time when boot-up of the paper ejection option unit 104 completes.

### [2] PROGRESS DISPLAY PROCESSING

Next, description is given on processing for displaying the boot-up progress of the image forming apparatus 1.

(2-1) Main Routine

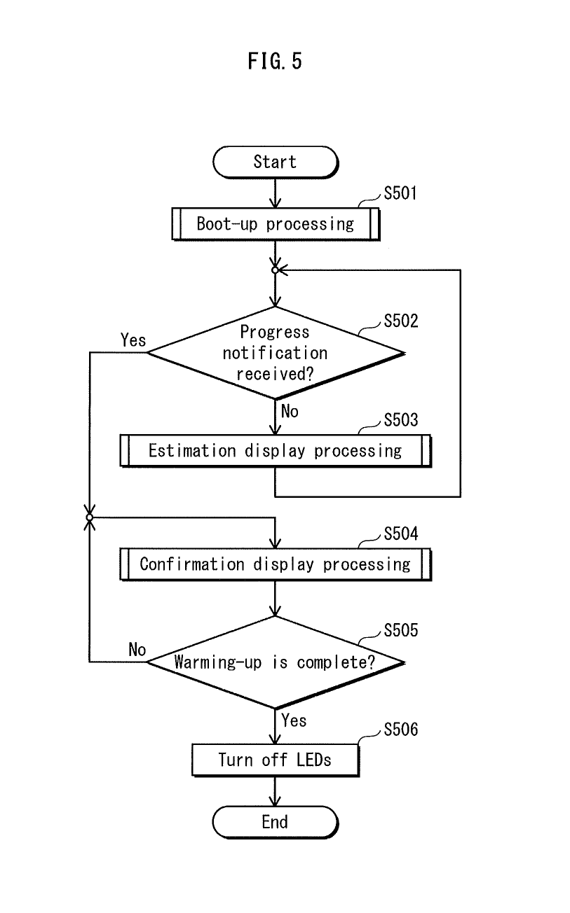

As a main routine of progress display processing, as shown in FIG. 5, upon power-on, the illumination display control subunit 202 performs boot-up processing (S501). Specifically, the illumination display control subunit 202 initializes a value of a progress counter to zero. After completing the boot-up processing, while not receiving a progress notification from the controller unit 102 yet (S502: NO), the illumination display control subunit 202 performs estimation display processing which is described later (S503). Until receiving the progress notification, the illumination display control subunit 202 repeatedly performs the estimation display processing with a control period of 100 milliseconds.

When receiving the progress notification from the controller unit 102 (S502: YES), the illumination display control subunit 202 performs confirmation display processing which is described later (S504). Until warming-up of the image forming apparatus 1 completes, the illumination display control subunit 202 repeatedly performs the confirmation display processing. When the warming-up completes (S505: YES), the illumination display control subunit 202 controls the illumination display subunit 203 to turn off all of the LEDs (S506), and then ends the main routine.

(2-2) Estimation Display Processing (S503)

Next, description is given on estimation display processing.

The illumination display control subunit 202 cannot know an actual warming-up progress of the image forming apparatus 1 until receiving a progress notification from the controller unit 102. For this reason, the illumination display control subunit 202 performs illumination display of the boot-up progress based on estimation.

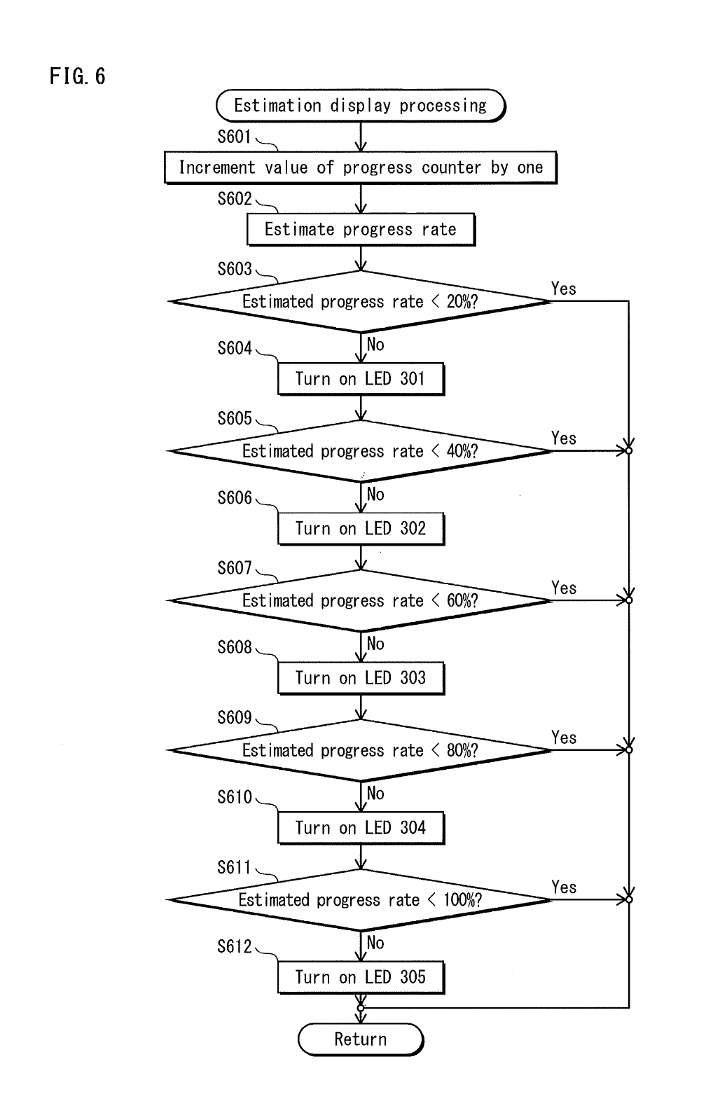

In estimation display processing as shown in FIG. 6, the illumination display control subunit 202 firstly increments the value of the progress counter by one (S601), and estimates a progress rate of boot-up (S602). The illumination display control subunit 202 repeatedly performs estimation display processing with a control period of 100 milliseconds, and accordingly the value of the progress counter is incremented by one for each 100 milliseconds. In other words, the progress counter indexes a period elapsed since boot-up completion of the illumination display control subunit 202.

Also, in the case where the standard warming-up completion period storage subunit 201 stores therein a standard warming-up completion period of 100 seconds, this period is converted to a value of the progress counter of 1000. Accordingly, an estimated value of the progress rate is given by the following equation.

Estimated value of progress rate=(Value of progress counter÷Standard warming-up completion period)×100%

If the estimated value of the progress rate is less than 20% (S603: YES), the illumination display control subunit 202 returns to an upper-level routine without turning on any of the LEDs. If the estimated value of the progress rate is equal to or greater than 20% (S603: NO), the illumination display control subunit 202 turns on the LED 301 (S604). Subsequently, the illumination display control subunit 202 turns on the LEDs 302 to 305 (S606, S608, S610, and S612) in accordance with the estimated value of the progress rate (S605, S607, S609, and S611), respectively, and then returns to the main routine.

(2-3) Processing by Controller Unit 102

The controller unit 102 receives, as a progress notification, a remaining period directly or indirectly from each of the document scanning unit 100, the engine unit 103, and the paper ejection option unit 104. The controller unit 102 selects the longest remaining period among the received remaining periods and a remaining period thereof. This is because the longest remaining period is judged to be close to a remaining period of the entire image forming apparatus 1.

After selecting the longest remaining period, the controller unit 102 transmits the longest remaining period as a progress notification to the illumination display control subunit 202.

Note that the controller unit 102 transmits the progress notification to the illumination display control subunit 202 after receiving the progress notifications from all of the document scanning unit 100, the engine unit 103, and the paper ejection option unit 104. This improves the precision of progress display.

(2-4) Confirmation Display Processing (S504)

Next, description is given on confirmation display processing.

After receiving the progress notification of the control unit whose remaining period is the longest from the controller unit 102, the illumination display control subunit 202 performs illumination display in accordance with the actual boot-up progress.

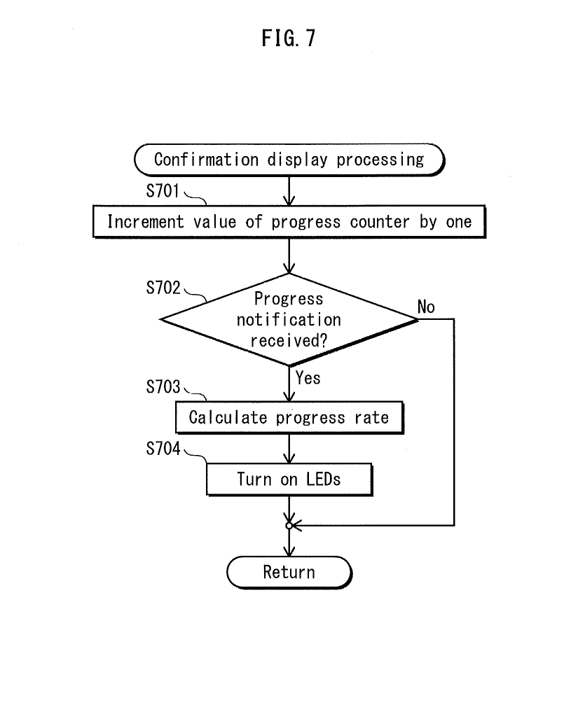

In confirmation display processing as shown in FIG. 7, the illumination display control subunit 202 firstly increments the value of the progress counter by one (S701). The confirmation display processing is also repeatedly performed with a control period of 100 milliseconds. Accordingly, the value of the progress counter is incremented by one for each 100 milliseconds continuously from the estimation display processing. This enables display of a period elapsed since the illumination display control subunit 202 has started counting up the progress counter, in other words, a period elapsed since boot-up completion of the illumination control unit 101.

Next, when receiving a progress notification from the controller unit 102 (S702: YES), the illumination display control subunit 202 calculates a progress rate (S703). The progress rate is calculated as follows. Firstly, a remaining period transmitted as the progress notification from the controller unit 102 is converted to a value of the progress counter, and the converted value is divided by 100 milliseconds. This results in a remaining period count value.

Remaining period count value=Remaining period÷100 milliseconds

With use of this remaining period count value, a confirmation value of the progress rate is given by the following equation.

Progress rate=Value of progress counter÷(Value of progress counter+Remaining period count value)×100%

In the case where the period elapsed since count-up of the progress counter has started is 50 seconds (=50,000 milliseconds) and the remaining period notified of by the controller unit 102 is 45,000 milliseconds, the value of the progress counter and the remaining period count value are calculated as follows.

Value of progress counter=50,000 milliseconds÷100 milliseconds=500

Remaining period count value=45,000 milliseconds÷100 milliseconds=450

Accordingly, the confirmation value of the progress rate is calculated as follows.

Confirmation value of progress rate=500÷(500+450)×100=57%

Then, the illumination display control subunit 202 turns on the LEDs in accordance with the confirmation value, in the similar way to in Steps S603 to S612 in FIG. 6 (S704). After performing processing in Step S704, and until receiving a progress notification from the controller unit 102 (S702: NO), the illumination display control subunit 202 returns to the main routine.

### [3] EXAMPLE OF PROGRESS DISPLAY

The following exemplifies progress display performed through the above processing.

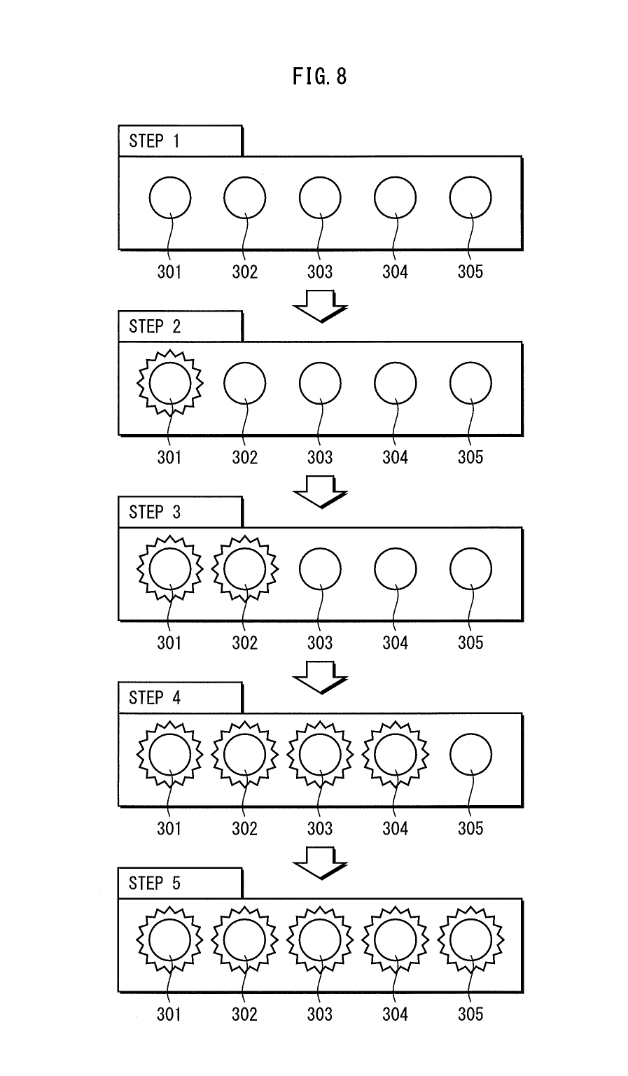

FIG. 8 exemplifies progress display performed by the illumination display subunit 203. The progress display starts from STEP 1 toward STEP 5. STEP 1 to STEP 3 each show a progress display before the illumination display control subunit 202 receives a progress notification from the controller unit 102. STEP 4 and STEP 5 each show a progress display after the illumination display control subunit 202 receives the progress notification from the controller unit 102.

According to the present embodiment as shown in FIG. 8, in the situation where all the LED are kept turned off, until receiving the progress notification from the controller unit 102, the illumination display subunit 203 turns on the LEDs one by one in the stated order of the LEDs 301, 302, . . . at intervals of four seconds (=20 seconds÷five stages). In other words, at the time immediately, after boot-up completion of the illumination control unit 101, all of the LEDs 301 to 305 are kept turned off (STEP 1). Then, for example, the LED 301 is firstly turned on after four seconds have elapsed since the boot-up completion (STEP 2), and the LED 302 is further turned on after eight seconds have elapsed since the boot-up completion (STEP 3).

Then, when the illumination display control subunit 202 receives the progress notification from the controller unit 102 until 12 seconds have elapsed since the boot-up completion and the progress rate calculated based on the progress notification is equal to or greater than 80% and less than 100%, the LEDs 303 and 304 are further turned on simultaneously (STEP 4). When the progress rate calculated based on the progress notification received from the controller unit 102 finally reaches 100%, the LED 305 is turned on to notify of warming-up completion of the image forming apparatus 1 (STEP 5).

According to the present embodiment as described above, even before boot-up completion of the controller unit 102, the illumination control unit 101 can display the warming-up progress of the image forming apparatus 1 in stages.

### [4] MODIFICATION EXAMPLES

Although the present invention has been described based on the above embodiment, the present invention is of course not limited to the above embodiment, and the following modification examples may be employed.

(1) In the above embodiment, the controller unit 102 receives a progress notification from each of the document scanning unit 100, the engine unit 103, and the paper ejection option unit 104, and then transmits a progress notification to the illumination control unit 101. However, the present invention is of course not limited to this configuration.

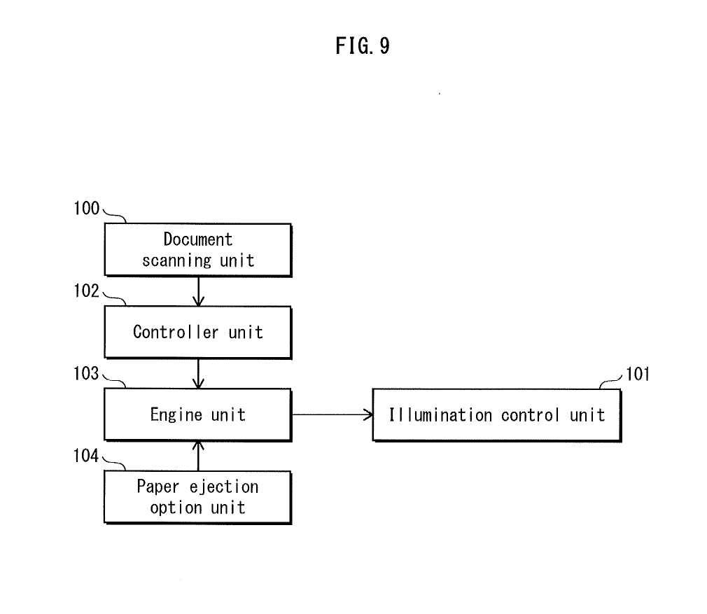

Alternatively, as shown in FIG. 9, the engine unit 103 may for example receive a progress notification from each of the document scanning unit 100, the controller unit 102, and the paper ejection option unit 104, and then transmit a progress notification to the illumination control unit 101. In this case, the engine unit 103 receives a remaining period as the progress notification from each of the document scanning unit 100, the controller unit 102, and the paper ejection option unit 104, and selects the longest remaining period among the received remaining periods and a remaining period of the engine unit 103.

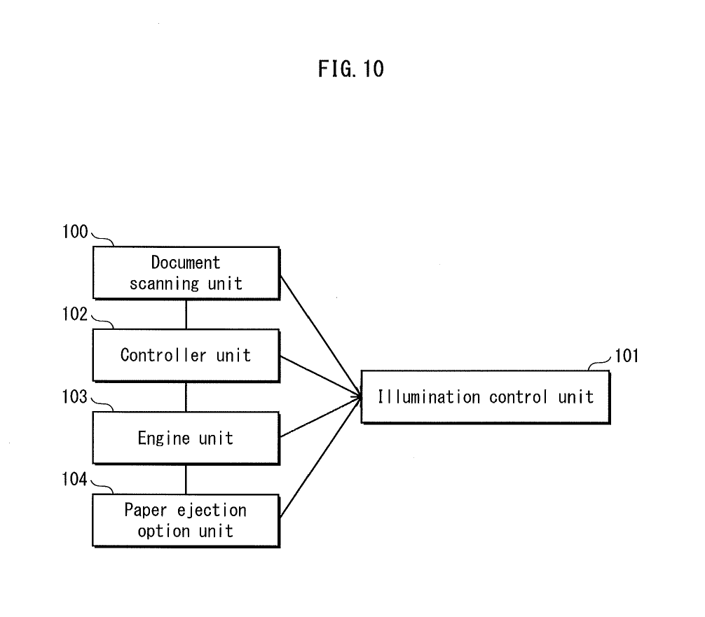

Further alternatively, as shown in FIG. 10, the illumination control unit 101 may receive a progress notification separately from each of the document scanning unit 100, the controller unit 102, the engine unit 103, and the paper ejection option unit 104, and then select the longest remaining period among remaining periods received as the progress notifications and a remaining period of the illumination control unit 101. In this case, until receiving the progress notifications from all of the document scanning unit 100, the controller unit 102, the engine unit 103, and the paper ejection option unit 104, the illumination control unit 101 repeatedly performs estimation display processing (S503). After receiving the progress notifications, the illumination control unit 101 performs confirmation display processing (S504).

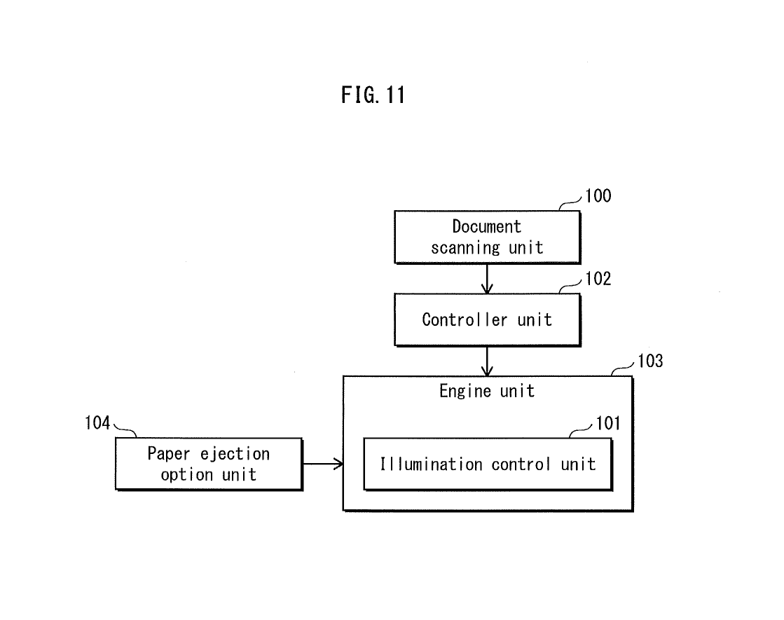

Yet alternatively, as shown in FIG. 11, the illumination control unit 101 may be built in the engine unit 103 so as to be connected to an internal bus of the engine unit 103, for example. In this case, upon receiving a progress notification from each of the document scanning unit 100, the controller unit 102, and the paper ejection option unit 104 after boot-up completion, the engine unit 103 transmits a progress notification to the illumination control unit 101.

(2) In the above embodiment, the description has been given on the case where the standard warming-up completion period is 100 seconds. However, the present invention is not of course limited to this configuration. Alternatively, other period may be used as the standard warming-up completion period. Also, the warming-up completion period can differ for each combination of a plurality of control units corresponding to the configuration type of the image forming apparatus (selection of an option). For this reason, the standard warming-up completion period may be changed in accordance with selection of an option.

For example, the standard warming-up completion period storage subunit 201 may be a non-volatile memory that stores therein the standard warming-up completion period which is rewritable by the controller unit 102. The controller unit 102 may rewrite the standard warming-up completion period in accordance with the configuration type of the image forming apparatus, selection of an option via the operation panel, or reception of input of the standard warming-up completion period.

Alternatively, a standard warming-up completion period for each option may be stored in advance in the standard warming-up completion period storage subunit 201, and a standard warming-up completion period to be read may be changed in accordance with selection of an option.

(3) In the above embodiment, the description has been given on the case where the illumination display control subunit 202 turns on the LEDs in accordance with a remaining period after reception of a progress notification, irrespective of the lighting status of the LEDs before the reception of the progress notification. However, the present invention is not limited to this configuration.

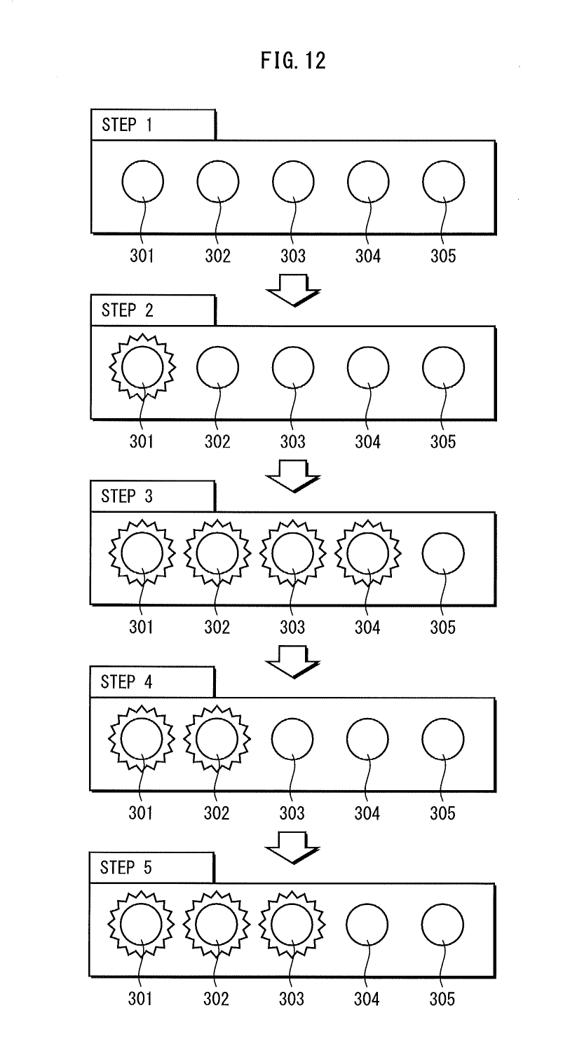

Alternatively, the following configuration may be employed as shown in FIG. 12. Firstly, the LEDs 301 to 305 are kept turned off (STEP 1). Until receiving a progress notification from the controller unit 102, the illumination display control subunit 202 turns on the LEDs 301 to 304 in the stated order at intervals of 20 seconds for each progress by 20% (STEP 2 and STEP 3). Then, when the progress rate, which is calculated based on the progress notification received from the controller unit 102, is equal to or greater than 40% and less than 60%, the illumination display control subunit 202 turns off the LEDs 303 and 304 (STEP 4). Then, the illumination display control subunit 202 again turns on the LED 303 in accordance with the progress notification (STEP 5).

With this configuration, even if the estimated value of the progress rate has some error in estimation display processing (S503), the value of the progress rate, which is calculated based on the progress notification received from the controller unit 102, is displayed in confirmation display processing (S504). Therefore, it is possible to improve the precision of progress display.

(4) In the above embodiment, the description has been given on the case where progress display is performed with use of the ratio of the elapsed period (value of the progress counter) to the standard warming-up completion period in estimation display processing (S503). However, the present invention is not limited to this configuration.

Alternatively, instead of the standard warming-up completion period, turn-on time intervals of the LEDs 301 to 305 may be for example stored in order to perform progress display in accordance with how many times the elapsed period is larger than the turn-on time intervals. In the case where progress display is performed in five stages, the progress rate is calculated as follows because of increase by 20% per stage.

Progress rate=(Value of progress counter÷Turn-on time intervals)×20%

Also, in the above embodiment, progress display is performed in five stages. Alternatively, progress display may be performed in stages whose number is other than five. For example, the illumination display subunit 203 may include LEDs whose number is equal to or greater than two and is other than five, and perform progress display in stages which are equal in number to the LEDs.

Further alternatively, progress display may be performed by displaying the progress rate in numerical value. For example, the illumination display subunit 203 may include a triple-digit seven-segment display to perform progress display by displaying the progress rate in percent.

(5) The numerical values of the standard warming-up completion period, the number of LEDs, and so on are just examples, and accordingly appropriate numerical values should be used as necessary.

(6) In the above embodiment, the description has been given on the case where a boot-up progress after power-on is displayed. However, the present invention is not limited to this configuration. Alternatively, in the case where all the units other than the illumination control unit 101, namely, the controller unit 102, the engine unit 103, and so on, are booted up even at any time other than the power-on time, the same effects as in the above embodiment can be exhibited by the illumination control unit 101 performing progress display.

(7) In the above embodiment, the description has been given on the case where the illumination control unit 101 includes a CPU and performs boot-up processing. However, the present invention is not limited to this configuration.

Alternatively, the illumination display control subunit 202 may for example have the hardware configuration of controlling the illumination display subunit 203 to perform progress display by turning on the LEDs one by one at predetermined time intervals until boot-up completion of the controller unit 102. After the boot-up completion of the controller unit 102, the controller unit 102 may directly control the illumination display subunit 203 to perform progress display. This configuration also exhibits the same effects as in the above embodiment.

(8) In the above embodiment, the description has been given on the case where the image forming apparatus 1 relating to the present invention includes the document scanning unit 100. However, the present invention is not limited to this configuration. Alternatively, the image forming apparatus 1 relating to the present invention may be a printer apparatus which does not include the document scanning unit 100. Further alternatively, the image forming apparatus 1 relating to the present invention may be a facsimile apparatus which is equivalent to the image forming apparatus 1 relating to the above embodiment additionally including a communication unit, or be an MFP (Multi-Function Peripheral) which has these functions. Yet alternatively, the image forming apparatus 1 relating to the present invention may form only monochrome images or both monochrome images and colored images. The same effects of the present invention are exhibited by each of the above cases.

### [5] SUMMARY

Finally, the following describes the summary of the effects exhibited by the above embodiment and the modification examples.

The image forming apparatus relating to the present invention includes a plurality of control units that are booted up in parallel after reset of the image forming apparatus, the image forming apparatus comprising: a display unit that displays, in multiple stages, an overall boot-up progress that is a boot-up progress of the entire image forming apparatus; a display control unit that controls the display unit to display the overall boot-up progress, wherein the display control unit includes: an estimation subunit that makes an estimation of the overall boot-up progress based on a period counted after the reset; and a reception subunit that receives a boot-up progress of each of the control units, and until receiving the boot-up progress of each of all of the control units, or until receiving the boot-up progress of a latest one of the control units in terms of completion of boot-up, the display control unit controls the display unit to display the overall boot-up progress based on the estimation, and after receiving the boot-up progress of each of all of the control units, or after receiving the boot-up progress of the latest control unit, the display control unit controls the display unit to display the overall boot-up progress based on the received boot-up progress.

With this structure, the display control unit is provided separately from the plurality of control units including the controller unit. Accordingly, it is possible to display the boot-up progress of the image forming apparatus even before boot-up completion of the controller unit without delaying the boot-up completion of the controller unit. Also, the display control unit refers to the boot-up progresses of the latest one of the control units in terms of boot-up completion. This enables progress display with a high precision.

In this case, it is preferable that the display control unit should be completely booted up earlier than any other of the control units.

Also, the estimation subunit may make the estimation with use of a ratio of the counted period to a standard boot-up period necessary for completion of boot-up of all of the control units after the reset. Furthermore, it is more preferable that the image forming apparatus should further comprise a storage unit that stores therein the standard boot-up period corresponding to a combination of the control units, the combination differing for each configuration type of the image forming apparatus, wherein the estimation subunit should make the estimation with use of the standard boot-up period corresponding to the combination.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. An image forming apparatus that includes a plurality of control units that are booted up in parallel after reset of the image forming apparatus, the image forming apparatus comprising:
a display unit that displays, in multiple stages, an overall boot-up progress that is a boot-up progress of the entire image forming apparatus;
a display control unit that controls the display unit to display the overall boot-up progress, wherein
the display control unit includes:
an estimation subunit that makes an estimation of the overall boot-up progress based on a period counted after the reset; and
a reception subunit that receives a boot-up progress of each of the control units, and
until receiving the boot-up progress of each of all of the control units, or until receiving the boot-up progress of a latest one of the control units in terms of completion of boot-up, the display control unit controls the display unit to display the overall boot-up progress based on the estimation, and
after receiving the boot-up progress of each of all of the control units, or after receiving the boot-up progress of the latest control unit, the display control unit controls the display unit to display the overall boot-up progress based on the received boot-up progress.

2. The image forming apparatus of claim 1, wherein
the display control unit is completely booted up earlier than any other of the control units.

3. The image forming apparatus of claim 1, wherein
the estimation subunit makes the estimation with use of a ratio of the counted period to a standard boot-up period necessary for completion of boot-up of all of the control units after the reset.

4. The image forming apparatus of claim 3, further comprising
a storage unit that stores therein the standard boot-up period corresponding to a combination of the control units, the combination differing for each configuration type of the image forming apparatus, wherein
the estimation subunit makes the estimation with use of the standard boot-up period corresponding to the combination.
